(19) United States
(12) Patent Application Publication
(10) Pub. No.: US 2011/0100533 A1
(43) Pub. Date: May 5, 2011

(54) METHOD AND PRODUCTION OF A ROTOR BLADE FOR WIND ENERGY PLANT

(75) Inventors: Jens Kulenkampff, Kiel (DE); Benn Faulkner, Ningwood Isle of Wight (GB)

(73) Assignee: REPOWER SYSTEMS AG, Hamburg (DE)

(21) Appl. No.: 13/000,535

(22) PCT Filed: Jun. 11, 2009
(86) PCT No.: PCT/EP2009/004210

§ 371 Date: Dec. 21, 2010

(30) Foreign Application Priority Data
Jun. 27, 2008 (DE) 10 2008 030 132.9
Jul. 31, 2008 (DE) 10 2008 035 588.7

(51) Int. Cl. B29C 65/48

(52) U.S. Cl. 156/182

(57) ABSTRACT

A method for producing a rotor blade for a wind power plant that in operational condition extends longitudinally from an area at the blade root for the connection at a rotor hub of the wind power plant, up to a blade tip, and that for its production is divided into at least two segments. The production of the rotor blade is facilitated and to the time required, is shortened especially for a series production. For its production, the rotor blade is segmented into more than two segments, that at least for a few of these segments separate manufacturing molds are provided that can be used temporally in parallel, and that for the final production of the rotor blade, the segments are connected together outside of a manufacturing mold into a rotor blade or a rotor blade part.

### BACKGROUND OF THE INVENTION

1. Field of the Invention

The invention relates to a method for producing a rotor blade for a wind power plant that in operational condition extends longitudinally from an area at the blade root for the connection to a rotor hub of the wind power plant, up to a blade tip, and that for its production is divided into at least two segments.

2. Description of Related Art

Divided or segmented rotor blades for a wind power plant, for facilitating their production, transport and assembly have, in principle, been known for a long time, for example from DE 31 13 079 A1. Because in the prior art, preferably transport is facilitated, the segments of the rotor blade are preferably only assembled at the installation site of the wind power plant, and are designed for this purpose.

In contrast, the object of the invention is to facilitate the production of the rotor blade and to shorten the required production time, especially for a series production.

This object is solved according to the invention, wherein for its production, the rotor blade is segmented into more than two segments, so that at least for a few of these segments separate manufacturing molds are provided to be or being used temporally in parallel, and that for the final production of the rotor blade, the segments are connected together outside of a manufacturing mold into a rotor blade or a rotor blade part.

By means of the method according to the invention, smaller segments can be advantageously produced temporally in parallel, and thereby the entire production cycle can be shortened, and the manufacturing molds involved and segments can be designed so that they are easy to handle in comparison to a production in which a rotor blade, possibly comprised of two half shells, is produced in total in a large manufacturing mold with a long production time. The productivity is thereby increased advantageously. In addition, quality control is facilitated because in the case of rejects, possibly occurring due to a defect in the production, if applicable, only one segment is affected and not the entire rotor blade. For connecting the segments into the final rotor blade, according to the invention, advantageously no costly manufacturing mold is necessary and provided, but rather for the final production, a connection is planned outside of one or any manufacturing mold.

In addition, in a further development of the invention the rotor blade or rotor blade part can be post-processed, for example, post-tempered, outside of a manufacturing mold.

In another further development of the method according to the invention the rotor blade or rotor blade part is finished, for example hardened, freed of residual adhesive, or residual resin or similar, outside of a manufacturing mold.

According to the invention, at least the connection of the segments, preferably, and possibly also a subsequent treatment or finishing, is performed in a separate joining device, especially in an adhesive frame.

One preferred embodiment of the method according to the invention is characterized in that the segments are manufactured using a plastics technology. Here, it is considered, in particular, that with plastics technology at least one resin and at least one fiber layer, especially, a layer composed of glass fibers and or carbon fibers are used. According to the invention, preferably a resin transfer molding (RTM) or a resin infusion molding (RIM) is used; in particular, a vacuum assisted resin infusion (VAR). Alternatively, or additionally, a lamination technology can also be used.

In a next further development of the invention, at least one subdivision for segmenting the rotor blade extends approximately in the longitudinal extension of the rotor blade. This helps to shorten the time of use of the manufacturing molds involved, and at the same time does not impact the structure and strength of the manufactured rotor blade, because force conducting and/or force transferring parts and segments, already in production, can extend uninterrupted substantially over the entire length of the rotor blade. According to the invention, however, it is also possible in addition or alternatively to provide divisions running transverse to the longitudinal extension of the rotor blade, and to connect the segments formed thereby quickly and reliably without sacrificing quality.

In a further development of the invention one or more bars or webs, one or more belts, one or more rotor blade root parts, at least one rotor blade tip segment, shell segments and/or rotor blade shells comprised of segments, are connected together in the joining device. In particular, segments and/or (other) elements can be adhesion bonded together in the joining device.

In another further development of the invention, at least one heating device is used, preferably in the area of the joining device, for heating, tempering, drying and/or hardening of elements and/or element connections.

A next further development of the invention is characterized in that initially the segments and/or other elements are hardened or pre-hardened, subsequently introduced into the joining device, connected together there, and subsequently the connection and/or the bond of the segments and/or other elements is dried and/or hardened, which can also advantageously take place in the joining device without occupying a manufacturing mold.

Another further development of the invention is characterized by the particular advantage that elements are produced temporally in parallel, and that the elements to be manufactured are designed, or are to be designed, particularly according to their type, characteristic and/or size, so that the mold occupancy times spent in the manufacturing molds used in parallel for this purpose are adapted to each other, and/or the occupancy time of the manufacturing mold to be occupied for the longest period, which determines the cycle time of a production cycle, is minimized which leads to, or accounts for, a significant increase in productivity.

Moreover, according to a further development of the method according to the invention, especially, due to segmenting at least one belt-bar assembly group can be pre-fabricated and supplied to the joining device for connection to other segments of the rotor blade. For this purpose, the belt-bar assembly group can preferably be created substantially as a box spar comprising at least two belts and two bars.

In a further development of the invention, a central longitudinal segment of the rotor blade can be formed by two subdivisions of the rotor blade running substantially in the longitudinal extension direction of the rotor blade, that comprise the belts and bars. Additionally or alternatively the rotor blade can be subdivided at least into a leading edge segment and a trailing edge segment by at least a subdivision running substantially in the longitudinal extension direction of the rotor blade.

In a further development of the invention, for which independent protection is claimed, the subdivisions of the rotor blade are preferably provided up through the rotor blade root parts so that inserts, for example, for a rotor blade root can also be segmented or belong to segments.

In another further development of the invention, a suction side and a pressure side or an upper shell and a lower shell are separated from each other for segmenting the rotor blade. Through additional subdivisions in the longitudinal direction of the rotor blade according to the invention, in this context quarters or sixths of the rotor blade, for example, can be formed for segmentation.

### BRIEF DESCRIPTION OF THE DRAWINGS

Exemplary embodiments from which further inventive features can also result, but to which the scope of the invention is not limited, are represented in the drawings. They show:

FIG. 1 an exemplary top view of a half shell of a rotor blade,

FIG. 2 a first embodiment example of a segmentation of a rotor blade according to the invention,

FIG. 3 a second embodiment example of a segmentation of a rotor blade according to the invention, and

FIG. 4 a third embodiment example of a segmentation of a rotor blade according to the invention.

### DETAILED DESCRIPTION OF THE INVENTION

First, it should be stated that the drawings in the figures show only schematic exemplary embodiments for the invention, for which diverse variations are possible in the scope of the invention. Additionally, none of the figures are represented true to scale or generally true to scale. The represented exemplary embodiments are sketched schematically only as possibilities in principle.

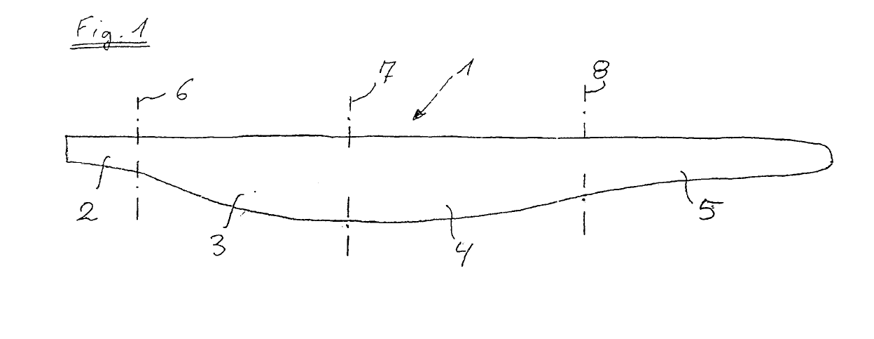

FIG. 1 shows a top view of a half shell 1 of a rotor blade. According to the invention, the represented half shell 1 can be subdivided into multiple segments 2 to 5. All or several of these segments 2 to 5 can each be produced or prefabricated substantially temporally in parallel to each other, and then are connected in the manner represented in FIG. 1 into a half shell 1 of a rotor blade, which can occur in an appropriate joining device. The segments 2 to 5 can be adhesively bonded together, for example, in this joining device.

Preferably, according to the invention, a segment is formed by a so-called rotor blade root 2, and the remaining half shell is subdivided into three segments 2 to 4. The segments 3 to 5 are designed with transverse divisions 6 to 8 so that they are approximately the same size and can be manufactured approximately equally quickly. These segments 3 to 5 can also, for example, be subdivided by a longitudinal division into further segments, or the half shell 1 can, for example, also be subdivided or segmented only by longitudinal divisions.

A preferably undivided belt runs over the segments 2 to 5, binding these segments together, which also and in particular, serves for force transfer during loading of a rotor blade disposed in a wind power plant. Instead of one belt, where applicable, two or more belts running substantially parallel to each other, and at an offset to each other, can also be provided, that is, for example, a so-called leading edge belt and a trailing edge belt, relative to the edges of the rotor blade to which they are closer.

A complete rotor blade is formed, for example, as a hollow body, in that a second mirror-inverted half shell 1 is placed on one half shell 1, and the two half shells 1 are connected together. Hot air, for example, can be introduced into this hollow body in order to further temper and completely harden the rotor blade. The half shells 1 or their segments are formed preferably by means of plastics technology in that, for example, glass fibers and/or carbon fiber layers are inserted or layered in a manufacturing mold, which specifies the three-dimensional design of these segments, and then are covered together with a vacuum film. This vacuum film is sealed vacuum-tight all around along the edges of the manufacturing mold, for example, with rubber-like bonding lines or double-sided adhesive tapes. Thereby, this vacuum film then forms a flexible counter form to the fixed manufacturing mold. In so-called vacuum fusion technology, an under pressure, a “vacuum”, is then created between the vacuum film and the manufacturing mold by air removal. The fiber layers are pressed against each other due to this under pressure, and a resin is suctioned out of a reservoir under the vacuum film, the resin is distributed uniformly over the entire form, and after their hardening, bonds the fiber layers securely to each other into a fixed plastic formed part, the respective segment. A uniform distribution of the resin can be attained in that multiple supply lines for the resin are installed, and suitable network layers or grid layers are inserted into the form which favor and guide the distribution and the laminar flow of the resin.

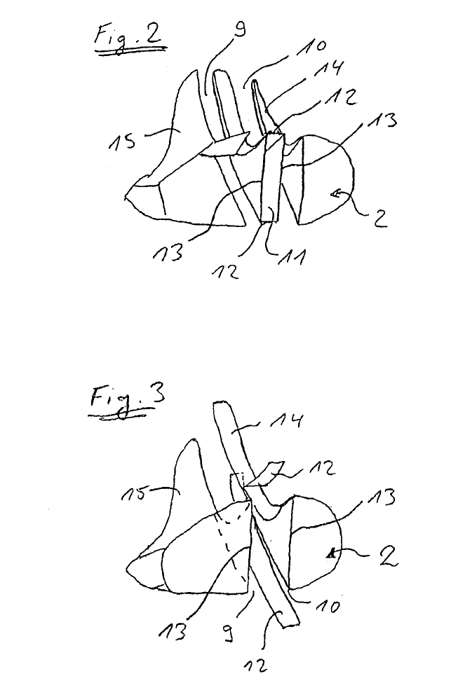

FIGS. 2 to 4 each show schematically and in a shortened perspective, and with a view into a rotor blade root 2, exemplary segmentations of a rotor blade according to the invention.

FIG. 2 shows a first embodiment example of a segmentation of a rotor blade according to the invention. In this segmentation, two subsections 9, 10 of the rotor blade that are running substantially in the longitudinal extension direction of the rotor blade are forming a center longitudinal section 11 of the rotor blade, that comprises the belts 12 and the webs 13. At the same time, at least a leading edge segment 14 and a trailing edge segment 15 are thereby formed. The subdivisions 9, 10 continue into the rotor blade root 2. Therefore, in this segmentation, substantially three segments 11, 14, 15 arise which are produced in different manufacturing molds, temporally in parallel and therefore faster, and that later can be connected together outside of any manufacturing mold into a complete rotor blade, whereby a rotor blade arises that is not qualitatively inferior to a known rotor blade, in particular with respect to the force transfer and strength.

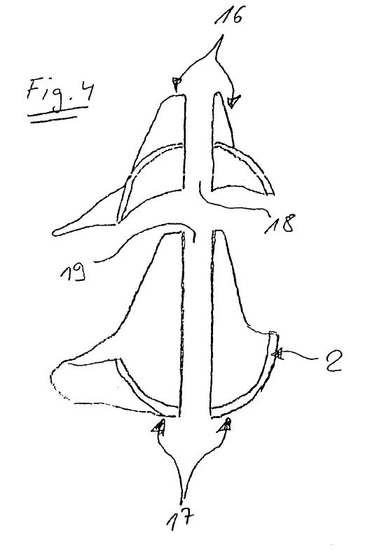

FIG. 3 shows a second embodiment example of a segmentation of a rotor blade according to the invention. Here too, due to two longitudinal sections 9, 10, a leading edge segment 14 and a trailing edge segment 15 result. However, instead of a central segment, here, additionally individual belts 12 and bars 13 or webs 13 are used to construct the rotor blade. The advantages are, however, substantially the same as in the first example embodiment according to FIG. 2.

FIG. 4 shows a third embodiment example of a segmentation of a rotor blade according to the invention. In this example embodiment, the rotor blade is divided into a lower shell 16 and an upper shell 17. Additionally these two shells 16, 17 are each further segmented by a longitudinal division 18, 19. Here too, the subdivisions 18, 19 continue through the rotor blade root 2 and the rotor blade is ultimately substantially quartered. Here also, the advantages are, however, substantially the same as in the first example embodiment according to FIG. 2.

Finally, a few features and advantages of the invention will be emphasized again. This emphasis or repetition does not indicate or cause any limitation of the scope of the invention either.

First, the invention can be based on the idea to produce individual segments of a rotor blade that each can be manufactured in their own manufacturing molds, temporally in parallel. In a parallel production of blade segments in different forms, the partial form with the longest cycle time defines the cycle time of the entire process, which this way can be advantageously shortened correspondingly. Thereby, an expedient segmenting of blades permits an adaptation of the forming times to each other, and thereby a high utilization coefficient, and also permits a reduction of the cycle time, whereby the cycle time of the entire process can be decreased and with it, the blade throughput can be increased.

For attaining a specific blade demand above the demand to be met by an individual form set, the entire form set need not to be multiplied, rather only the forms having a cycle time approaching the total cycle time. Forms with shorter cycle times can be used multiple times in order to serve the other forms. Thereby, at the same time, the space requirement is reduced and the productivity increased. The investment need is also reduced. Additionally, for example, bonding and tempering of segments can occur in parallel outside of the forms. The space requirements and the investment needs are not substantially increased either by a possibly required adhesive frame for this purpose.

1. A method for producing a rotor blade for a wind power plant that in operational condition extends longitudinally from an area at the blade root for the connection to a rotor hub of the wind power plant, up to a blade tip, and that for its production is divided into at least two segments, characterized in that the rotor blade for its production is segmented into more than two segments, that at least for a few of these segments separate manufacturing molds are provided to be used temporally in parallel, and that for the final production of the rotor blade, the segments are connected together outside of a manufacturing mold into a rotor blade or a rotor blade part

2. The method according to claim 1, characterized in that the rotor blade or rotor blade part is post-processed outside of a manufacturing mold.

3. The method according to claim 1 or 2, characterized in that the rotor blade or rotor blade part is finished outside of a manufacturing mold.

4. The method according to one of the preceding claims, characterized in that at least the connection of the segments is performed in a separate joining device, especially in an adhesive frame.

5. The method according to one of the preceding claims, characterized in that the segments are produced using plastics technology.

6. The method according to claim 5, characterized in that with plastics technology, at least one resin and at least one fiber layer, especially a layer composed of glass fibers and or carbon fibers are used.

7. The method according to claim 6, characterized in that resin transfer molding (RTM) is used.

8. The method according to claim 5 or 6, characterized in that resin infusion molding (RIM) is used, especially vacuum assisted resin infusion (VAR).

9. The method according to one of claims 5 through 8, characterized in that lamination technology is used.

10. The method according to one of the preceding claims, characterized in that at least one subdivision for segmenting the rotor blade is provided extending approximately in the longitudinal extension of the rotor blade.

11. The method according to one of the preceding claims, characterized in that one or more bars, one or more belts, one or more rotor blade root parts, at least one rotor blade tip segment, shell segments and/or rotor blade shells comprised of segments, are connected together in the joining device.

12. The method according to claim 11, characterized in that segments and/or (other) elements are adhesively bonded together in the joining device.

13. The method according to one of the preceding claims, characterized in that at least one heating device is provided, preferably in the area of the joining device, for heating, tempering, drying and/or hardening of elements and/or element connections.

14. The method according to one of the preceding claims, characterized in that initially the segments and/or other elements are hardened or pre-hardened, subsequently inserted into the joining device, are combined together there, and then the connection and/or the compound of the segments and/or other elements is dried and/or hardened.

15. The method according to one of the preceding claims characterized in that a production of the elements is performed temporally in parallel, in which the elements to be produced, are or will be designed, particularly according to their type, characteristics and/or size, so that the form occupancy times of the manufacturing mold used for this in parallel are equalized to each other and/or the occupancy time of the manufacturing mold to be occupied for the longest period, which determines the cycle time of a production cycle, is minimized.

16. The method according to one of the preceding claims, characterized in that due to segmenting at least one belt-bar assembly group is pre-fabricated, and supplied into the joining device for connection to other segments of the rotor blade.

17. The method according to claim 16, characterized in that the belt-bar assembly group is created substantially as a box spar comprising at least two belts and two bars.

18. The method according to one of the preceding claims, in particular, according to claims 10 and 17, characterized in that by two subdivisions of the rotor blade running substantially in the longitudinal extension direction of the rotor blade, a central longitudinal segment of the rotor blade can be formed that comprises the belts and bars.

19. The method according to one of the preceding claims, characterized in that the rotor blade is subdivided by at least a subdivision running substantially in the longitudinal extension direction of the rotor blade into at least a leading edge segment and a trailing edge segment.

20. The method according to one of the preceding claims, preferably according to claim 18 or 19, characterized in that the subdivisions of the rotor blade are provided up through the rotor blade root parts.

21. The method according to one of the preceding claims, characterized in that for segmenting the rotor blade a suction side and a pressure side can be separated from each other.
